(19) United States
(12) Patent Application Publication
(10) Pub. No.: US 2022/0003406 A1
(43) Pub. Date: Jan. 6, 2022

(54) SYSTEM AND PROCESS FOR HYDROGEN COMBUSTION

(71) Applicant: Roberto Ruiz, Sammamish, WA (US)

(72) Inventor: Roberto Ruiz, Sammamish, WA (US)

(21) Appl. No.: 17/365,784

(22) Filed: Jul. 1, 2021

Related U.S. Application Data
(60) Provisional application No. 63/047,338, filed on Jul. 2, 2020.

(51) Int. Cl. F22B 1/00; F23N 1/00; F23C 9/08; F23L 7/00

(52) U.S. Cl. CPC F22B 1/003; F23N 1/005; F23L 2900/00; F23L 7/002; F23C 9/08

(57) ABSTRACT

The invention relates to a system and process for hydrogen combustion for industrial or steam generation applications, and more particularly to a hydrogen combustion burner or retrofit kit combustion system and process using a primary pure hydrogen fuel source. The burner or retrofit kit combustion system and process may also use one or more secondary fuels, such as natural gas, methane, propane, or the like, to reduce emissions of CO₂. Additionally, the inventive burner, system and process can use a flame temperature reducing fluid for lowering the bulk flame temperature of the burner to increase equipment life and decrease equipment failure. The flame temperature reducing fluid can include flue gas recirculation (FGR), water injection, steam injection, and a combination thereof.

### CROSS REFERENCE TO RELATED APPLICATIONS

This application claims the benefit of U.S. Provisional Patent Application No. 63/047,338 filed on Jul. 2, 2020. This application incorporates the foregoing application by reference into this document as if fully set out at this point.

### BACKGROUND OF THE INVENTION

### 1. Field of the Invention

This invention relates generally to a system and process for hydrogen combustion for industrial or steam generation applications.

### 2. Description of the Related Art

The use of hydrogen in combustion applications is fairly limited to date, and it is only used when it is a byproduct of a combustion process. For example, in oil refineries and petrochemical plants, blends of hydrocarbon gases and hydrogen in typical concentrations in the range of 5-60% by volume are commonly combusted to provide heat in process heaters and boilers. The hydrogen in the blends is a byproduct of the refining or chemical process when oil or other hydrocarbons are cracked releasing hydrogen with other light hydrocarbons, such as methane (CH₄), propane (C₃H₈), ethane (C₃H₆), among others. This blended hydrogen is burned despite hydrogen's high economic value because it is more expensive to separate it from the other gases to achieve its purification.

As opposed to carbon dioxide (CO₂) emitting hydrocarbon gases—widely used to provide heat in industrial, commercial, residential, and electricity generation (e.g., methane, propane or natural gas)—pure hydrogen (defined as H₂ with a purity higher than 99%) combustion only emits water vapor (H₂O).

The oxidation of methane (CH₄) and hydrogen (H₂) and their respective products of combustion are presented in the chemical reactions below for illustration purposes:

CH₄+2O₂═CO₂+2H₂O (Equation 1)

2H₂+O₂═2H₂O (Equation 2)

The ever-increasing concentration of CO₂ in the atmosphere has reached levels not seen in the modern world before. Rising CO₂ levels are attributed primarily to the ubiquitous burning of fossil fuels, which has accelerated with energy demand by developed and developing countries in the last five decades. Many countries have taken notice to the correlation of climate change and rising fossil fuel use with the corresponding CO₂ levels and are taking action to reduce or eliminate fossil fuels. The spectral characteristics of CO₂ contribute to the absorption of radiation in in the environment creating a greenhouse effect. In addition, CH₄ is an even bigger contributor to the greenhouse effect when it is released into the environment. CH₄ release occurs from wells during its production or due to leakage from pipelines, valves and compression equipment during its distribution and use. The impact of CO₂ and CH₄ on climate change is creating opportunities for alternatives to the combustion of hydrocarbons. Hydrogen combustion being one of the solutions.

Although hydrogen is the most abundant element in the universe, on earth, it is mostly present as water. Because of this, hydrogen gas must be manufactured. The most common manufacturing technique is steam methane reforming (SMR) where water and natural gas react in a heated catalyst bed forming H₂, carbon monoxide (CO), and CO₂. Hydrogen is then typically separated in a molecular sieve to provide the proper purity. Another H₂ production method is via hydrolysis, which is the separation of hydrogen and oxygen in water using an electric current. Pure hydrogen worldwide consumption is dominated by demand in oil refining for hydrotreating and hydrocracking. Hydrotreating is a process to remove sulfur from organic compounds while hydrocracking is a process to break hydrocarbon molecules in petroleum to simpler molecules. Hydrogen is also used in the manufacture of other chemicals such as ammonia (NH₃). Smaller quantities of pure hydrogen are also used in the float glass industry to prevent oxidation over the tin bath. The advent of fuel cells is also seeing consumption of pure hydrogen, but its use is fairly small to date. Pure hydrogen combustion for industrial or utility applications is essentially nonexistent to date.

Pure hydrogen is a viable solution to eliminate emissions of CO₂ in combustion applications; however, the properties and characteristics of H₂ provide some challenges for its use as a combustion fuel. Hydrogen as a fuel is highly flammable, which requires special care and handling during transportation, storage, distribution, and use. It is also very light, which requires special safety considerations, and has a higher adiabatic flame temperature (4010° F. in air vs. 3565° F. for CH₄) and diffusivity (70×10-6 m²/s H₂ in air vs. 16×10-6 m²/s for CH₄ in air at 300K) than other conventional fuels requiring special burner design features and operation to avoid failure (i.e., melting, fatigue or thermal shock) of metallic or ceramic components in boilers or furnaces.

Regarding the adiabatic temperature of flames, it is important to point out that most existing commercial combustion equipment (i.e., burners) incorporates one or several strategies to reduce peak flame temperature to control emissions of nitrogen oxides (NOₓ), a highly regulated pollutant which is a precursor to photochemical smog. The strategies aim to lower peak flame temperatures below 2700° F. as NOₓ formation above this temperature increases at an exponential level.

The most common types of burners are diffusion-style and pre-mix burners. Diffusion-style burners are comprised of a fuel delivery system encompassing one or several nozzles 100 ejecting a hydrocarbon or a blend of hydrocarbons (FIGS. 1A and 1B). In pre-mix burners, fuel 102 and the oxidant 104 are ejected from the same nozzle 100 as a mixture. The fluid leaving the nozzle(s) 100 forms a turbulent jet 106 with vortices on its shear layer 108 where mixing with co-flowing air (diffusion-style) occurs or where mixing with flue gases within the combustion space (pre-mixed style) occurs. Peak flame temperatures 110 occur within these vortices at the location where the fuel/air equivalence ratio is close to 1.0. Combustion NOₓ reduction strategies, including fuel staging, air staging, flue gas recirculation (FGR), steam injection, water injection, and others aim to lower peak flame temperatures not bulk flame temperatures.

Conventional burners, including low NOₓ and ultra-low NOₓ burners must incorporate some means of flame stabilization. In combustion systems, one of the characteristics of fuels is their flame speed. When the velocity of the fuel exceeds the flame speed, the flame detaches from the burner and gets extinguished. It is unsafe to experience flame detachment. In confined spaces, such as those in furnaces or boilers, destabilization and detachment lead to unburned fuel accumulation. Hot surfaces within the confined space may reignite the fuel leading to an explosion. In other applications where the combustion process is conducted in an open space (e.g., flaring of gas), flame destabilization and detachment could lead to a vapor cloud and the potential hazard of vapor cloud ignition.

Methods for flame stabilization are a critical component in burner design. Typical methods for flame stabilization aim to create zones where the fuel velocity drops below the flame speed. Some of the most common stabilization methods include mechanically or aerodynamically swirling the flow, flow separation with bluff bodies or surface expansion, trapped vortex, and radial injection of a portion of the fuel, among others. Jet stabilization can be accomplished if there are no mechanical or aerodynamic stabilization methods incorporated into the burner design. In jet stabilization, the flame anchors itself onto the fuel nozzle or a short distance away from the nozzle. Jet stabilization with hydrocarbon fuel systems is not deemed viable as the range of fuel flow rates under which stabilization can be safely accomplished is fairly limited. That is, the turndown ratio (i.e., the ratio of maximum fuel flow rate to minimum fuel flow rate) has a range that is impractical and makes operation unsafe. The high diffusivity characteristics of hydrogen make jet stabilization an alternative to conventional mechanical and aerodynamic stabilization techniques. For pre-mixed combustion systems, the high diffusivity of hydrogen increases the propensity of flashback, which makes burner design, stabilization, and operation more challenging.

Another factor that impacts stabilization and the associated safety of combustion systems is heat transfer. That is, if a flame loses more heat than it generates, it will not be able to sustain continuous ignition and will extinguish itself. Excessive heat loss can occur from furnace or boiler surfaces that are too cold, or from too much supply of air or diluents (e.g., N₂, CO₂, FGR, steam, water) to the combustion process.

As far as FGR, steam and water injection are concerned, there is a limit to how much of these fluids can be introduced into the combustion process to lower peak flame temperature with conventional fuels. Typically, most combustion systems have an FGR limit below 45% FGR by volume before stability issues arise. Similarly, water injection and steam injection are typically limited to 1.5 lbs. of H₂O/lbs. of fuel and 0.35 lbs. of steam/lbs. of fuel, respectively. Because H₂ has a high diffusivity, it has a higher propensity to anchor its flame to the burner nozzle thus enhancing stabilization. Injection limits of diluents, such as FGR, water and steam, can be extended with H₂ combustion beyond the limits experienced by conventional hydrocarbon fuels. This allows the enhanced stabilization characteristics of H₂ to be a more effective fuel when flame temperature control is required. In addition, adiabatic flame temperature increases when air is replaced by oxygen-enriched air (O₂ concentration of about 23-90%) or oxy-fuel (O₂ concentration of about 90-100%) leading to enhanced stabilization as well. Higher levels of diluents can then further counterbalance the higher flame temperatures when O₂ is introduced.

It is therefore desirable to provide an improved system and process for hydrogen combustion for industrial or steam generation applications.

It is further desirable to provide a system and process for hydrogen combustion that utilizes a new burner design or a burner design that is retrofitted into existing burner systems.

It is still further desirable to provide a hydrogen combustion burner or a hydrogen retrofit kit combustion system and process that uses pure hydrogen as a primary fuel source in an independent and dedicated primary fuel supply circuit (i.e., piping, valves, manifold and burner nozzle(s)) and one or more secondary fuels in a separate secondary fuel supply circuit to reduce emissions of CO₂ and other greenhouse gases into the atmosphere.

It is yet further desirable to provide a hydrogen combustion burner or a hydrogen retrofit kit combustion system and process that uses a primary pure hydrogen fuel source (alone or with one or more secondary fuels) and at least one flame temperature reducing fluid to lower a bulk flame temperature of the burner in the boiler to reduce emissions of CO₂ and other greenhouse gases into the atmosphere.

It is still yet further desirable to provide a hydrogen combustion burner or a hydrogen retrofit kit combustion system and process wherein one or more of the boiler burners are configured to combust pure oxygen or oxygen enriched air (i.e., oxygen concentration greater than about 21% by volume) to reduce emissions of NOₓ and other greenhouse gases into the atmosphere.

Before proceeding to a detailed description of the invention, however, it should be noted and remembered that the description of the invention which follows, together with the accompanying drawings, should not be construed as limiting the invention to the examples (or embodiments) shown and described. Those skilled in the art to which the invention pertains will be able to devise other forms of this invention within the ambit of the appended claims.

### SUMMARY OF THE INVENTION

In general, the invention relates to a system and process for hydrogen combustion for industrial or steam generation applications. More particularly, the invention relates a hydrogen combustion burner or retrofit kit combustion system and process using pure hydrogen as a primary fuel source in the boiler system. The hydrogen combustion burner or retrofit kit combustion system and process may also use one or more secondary fuels, such as natural gas, methane, propane, or the like, to reduce emissions of CO₂. Additionally, the inventive burner, system and process can use a flame temperature reducing fluid for lowering the bulk flame temperature of the burner in the boiler system to reduce CO₂ emissions. The flame temperature reducing fluid can include flue gas recirculation (FGR), water injection, steam injection, and a combination thereof, among others. The inventive hydrogen combustion burner or a hydrogen retrofit kit combustion system and process reduce emissions of CO₂, NOₓ, and other greenhouse gases into the atmosphere, and they also reduce bulk flame temperatures to increase equipment life and decrease equipment failure.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1A is a flame profile of a prior art diffusion-style burner illustrating the fuel leaving the nozzle forming a turbulent jet with vortices on its shear layer where mixing with co-flowing air, and/or internal flue gases, occurs.

FIG. 1B is a closeup of view of area 1B of the temperature and flow profile from FIG. 1A pinpointing the location within the vortices where the fuel/air equivalence ratio is close to 1.0.

FIG. 2 is a schematic diagram of an example of a hydrogen combustion burner or retrofit kit combustion system having a burner nozzle that combusts a primary pure hydrogen fuel stream with an oxidant in accordance with an illustrative embodiment of the invention disclosed herein.

FIG. 3 is a schematic diagram of an example of a hydrogen combustion burner or retrofit kit combustion system having a manifold connected to a plurality of burner nozzles for combusting a primary pure hydrogen fuel stream with an oxidant in accordance with an illustrative embodiment of the invention disclosed herein.

FIG. 4 is a schematic diagram of an example of a hydrogen combustion burner or retrofit kit combustion system having a burner nozzle that combusts a primary pure hydrogen fuel stream with an oxidant and one or more secondary fuels in accordance with an illustrative embodiment of the invention disclosed herein.

FIG. 5 is a schematic diagram of an example of a hydrogen combustion burner or retrofit kit combustion system having a primary fuel manifold connected to a plurality of primary fuel burner nozzles and a secondary fuel manifold connected to a plurality of secondary fuel burner nozzles for combusting a primary pure hydrogen fuel stream, an oxidant, and a secondary fuel in accordance with an illustrative embodiment of the invention disclosed herein.

FIG. 6 is a schematic diagram of an example of a hydrogen combustion burner or retrofit kit combustion system having a primary fuel manifold connected to a plurality of primary fuel burner nozzles and a secondary fuel manifold connected to a plurality of secondary fuel burner nozzles for combusting a primary pure hydrogen fuel stream, an oxidant, and a plurality of secondary fuels in accordance with an illustrative embodiment of the invention disclosed herein.

FIG. 7 is a schematic diagram of an example of a hydrogen combustion burner or retrofit kit combustion system having a burner nozzle that combusts a primary pure hydrogen fuel stream with an oxidant and at least one flame temperature reducing fluid in accordance with an illustrative embodiment of the invention disclosed herein.

FIG. 8 is a schematic diagram of an example of a hydrogen combustion burner or retrofit kit combustion system having a primary fuel manifold connected to a plurality of primary fuel burner nozzles, a secondary fuel manifold connected to a plurality of secondary fuel burner nozzles, and a stream of flame temperature reducing fluid for combusting a primary pure hydrogen fuel stream, an oxidant, a secondary fuel, and the flame temperature reducing fluid in accordance with an illustrative embodiment of the invention disclosed herein.

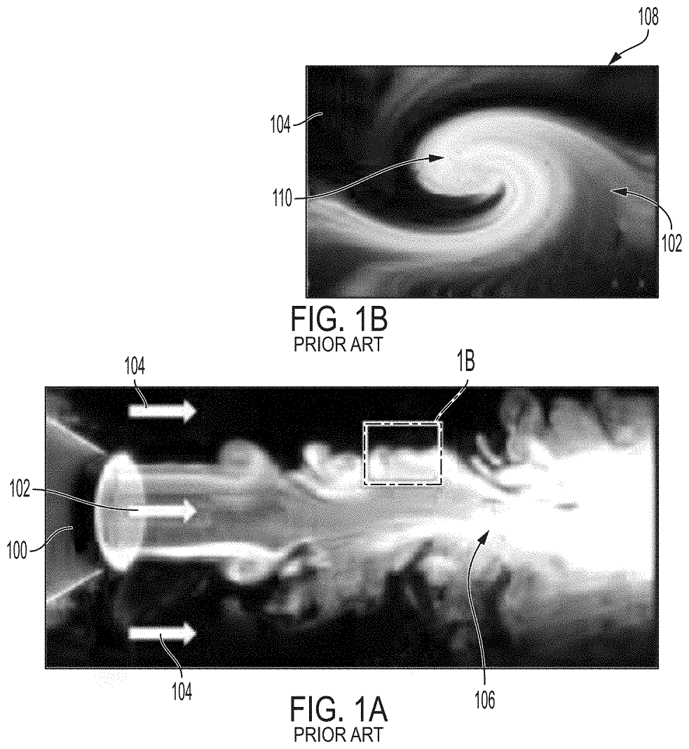

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments so described.

This invention relates generally to a system and process for hydrogen combustion, and more particularly to a combustion burner or retrofit kit combustion system and process having at least one burner nozzle using pure hydrogen as a primary fuel source. Pure hydrogen herein as used herein means H₂ with a purity higher than 99%. The inventive system and process may also use the primary pure hydrogen fuel with one or more secondary fuels and/or a flame temperature reducing fluid for lowering a bulk flame temperature of the burner or retrofit kit combustion system. The inventive combustion burner or retrofit kit combustion system and process reduce emissions of CO₂, NOₓ, and other greenhouse gases into the atmosphere and reduce bulk flame temperatures to increase equipment life and decrease equipment failure. The combustion burner or retrofit kit combustion system and process can be incorporated into a boiler system of any type of design, such as firetube, watertube, utility, single burner, multiple-burner, side-fired, bottom-fired, roof-fired, tangentially-fired, either skid-mounted or field-erected, or a combination thereof.

The hydrogen combustion burner or retrofit kit combustion system has a primary pure hydrogen fuel stream delivered to at least one burner nozzle where it burns with an oxidant. The burner or retrofit kit combustion system can be configured for use with various oxidants, such as combustion air, pure oxygen to avoid NOₓ emissions, or oxygen-enriched air (i.e., oxygen concentration greater than about 21% by volume) with the objective of reducing overall oxygen cost or in case pure oxygen is not available to satisfy the combustion capacity needs. In an exemplary embodiment of the system and process, the primary hydrogen fuel is combusted with air, pure oxygen, oxygen-enriched air, oxy-fuel, or a combination thereof to reduce greenhouse gas emissions. The inventive hydrogen combustion burner or retrofit kit combustion system can include one or more flow valves and controls as needed to selectively control fluid flow through the inventive system and process.

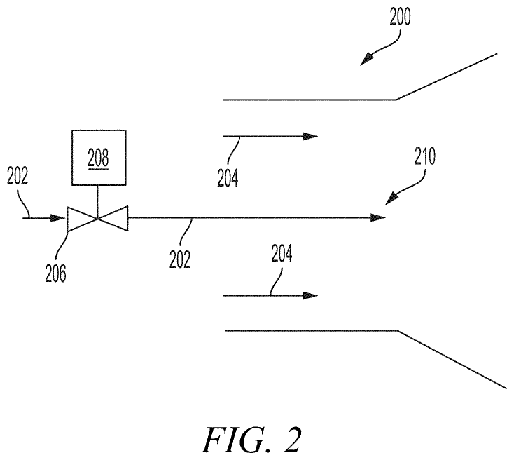

Referring now to the FIGS. 2 through 8, wherein like numerals of reference designate like elements throughout the several views, and initially to FIG. 2, the illustrated hydrogen combustion burner or retrofit kit combustion system 200 utilizes a single burner nozzle 210 for combusting the primary pure hydrogen fuel 202 and the oxidant 204 (e.g., air, pure oxygen, oxygen-enriched air). A primary fuel flow valve 206 and control 208 selectively controls the primary fuel 202 fluid flow to burner 200 for combustion with the oxidant 204.

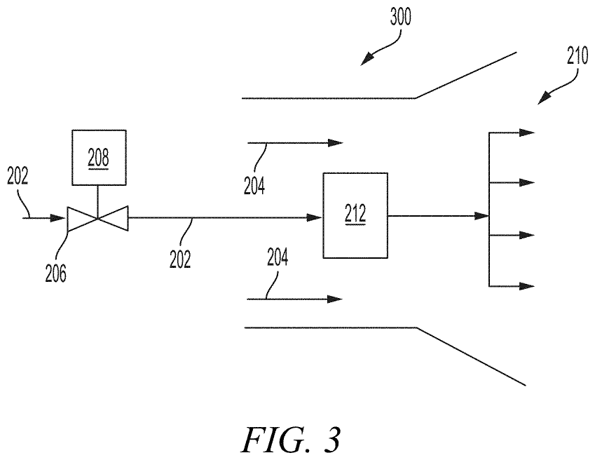

As illustrated in FIG. 3, the hydrogen combustion burner or retrofit kit combustion system 300 includes a primary fuel manifold 212 connected to a plurality of burner nozzles 210 where the primary pure hydrogen fuel 202 is combusted with the oxidant 204. The primary fuel flow valve 206 and control 208 selectively controls the primary fuel 202 fluid flow to the hydrogen combustion burner or retrofit kit combustion system 200 for combustion with the oxidant 204.

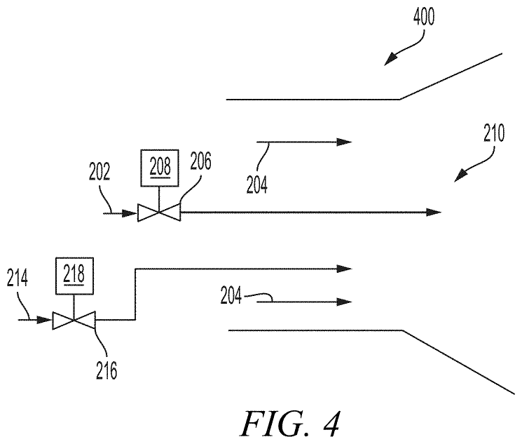

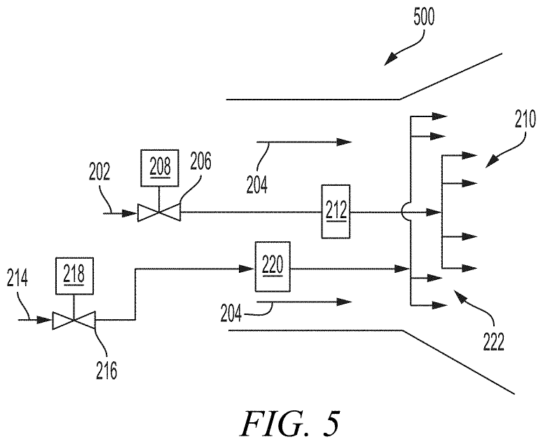

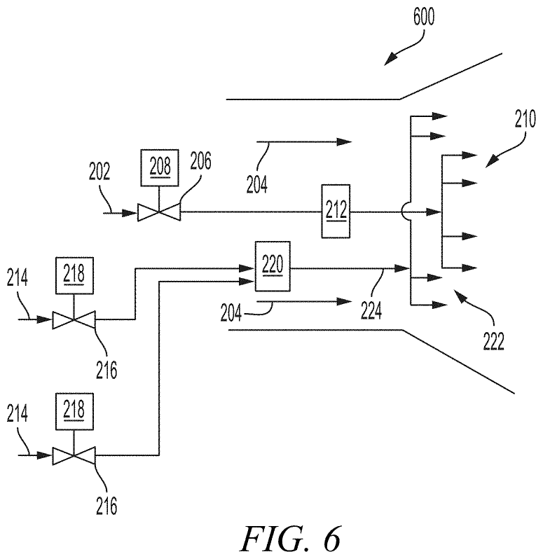

As exemplified in FIGS. 4, 5 and 6, the hydrogen combustion burner or retrofit kit combustion system 400/500/600 includes the primary fuel manifold 212 connected to the plurality of burner nozzles 210 where the primary pure hydrogen fuel 202 is combusted with the oxidant 204. In addition to the primary pure hydrogen fuel 202, the hydrogen combustion burner or retrofit kit combustion system 400 includes one or more secondary fuels 214 that mix and combust with the primary hydrogen fuel 202 and oxidant 204 to further reduce emissions of CO₂. The secondary fuel(s) 214 can include any hydrocarbon fuel, such as natural gas, methane, propane, or mixtures thereof in compositions greater than 5% by volume of the overall burner capacity. A secondary fuel flow valve 216 and control 218 selectively controls the secondary fuel 214 fluid flow to the hydrogen combustion burner or retrofit kit combustion system 400 for combustion with the oxidant 204. The secondary fuel 214 stream can be separate and independent from the primary hydrogen fuel 202 stream. Moreover, the secondary fuel(s) 214 can be introduced to the burner 400 in individual fluid stream(s) (FIG. 4), introduced to the burner 500 through a secondary fuel manifold 220 connected to a plurality of secondary fuel burner nozzles 222 (FIG. 5), or introduced to the burner 600 as a single mixed secondary fuel fluid stream 224 before injection into the secondary fuel burner nozzles 222 (FIG. 6).

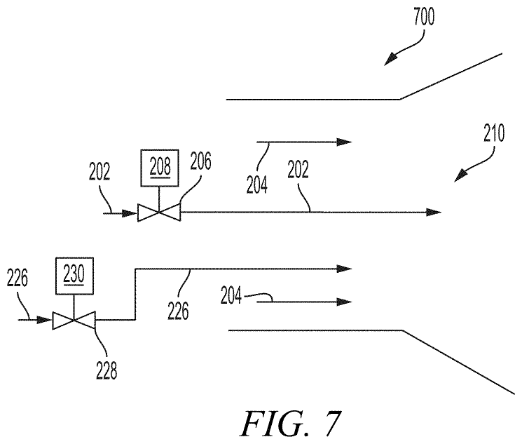

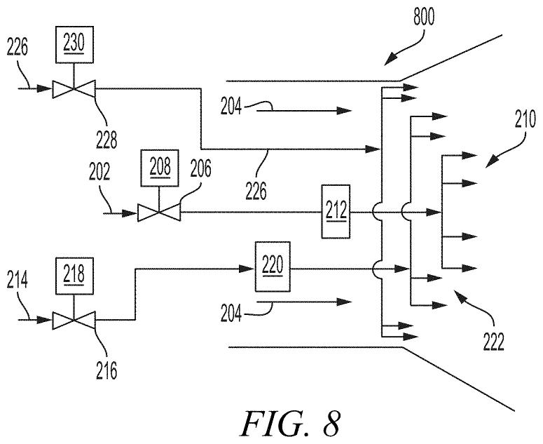

Turning now to FIGS. 7 and 8, the inventive system and process can use at least one flame temperature reducing fluid 226 to lower the bulk flame temperature of the burner or retrofit kit combustion system 700/800. The flame temperature reducing fluid 226 can be water or steam input from a suitable source or flue gas recirculated from combustion and mixed with the oxidant 204 or otherwise injected into the burner 700/800, or a combination thereof. A flame temperature reducing fluid flow valve 228 and control 230 controls in the injection flow rate of the flame temperature reducing fluid 226 to the hydrogen combustion burner or retrofit kit combustion system 700/800 to selectively lower the flame temperature during combustion of the primary pure hydrogen fuel 202 (and the secondary fuel(s) 214 if present).

The flame temperature reducing fluid 226 can be used separately (FIG. 7) or in conjunction with the secondary fuel source 214 (FIG. 8). The flame temperature reducing fluid 226 can also be separately or concurrently injected into one or more of the burners 700/800 configured to combust pure oxygen or oxygen-enriched air as the oxidant 204. In the exemplary embodiment of the system and process for hydrogen combustion shown in FIG. 8, the primary hydrogen fuel source 202 and the secondary fuel source 214 are combusted with pure oxygen or oxygen-enriched air 204 while the bulk flame temperature is lowered using the flame temperature reducing fluid 226 to reduce CO₂ and NOₓ emissions and to increase equipment life and decrease equipment failure.

It is to be understood that the terms “including”, “comprising”, “consisting of” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Systems and processes of the instant disclosure may be implemented by performing or completing manually, automatically, or a combination thereof, selected steps or tasks.

The term “process” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a process comprising two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility).

Still further, additional aspects of the instant invention may be found in one or more appendices attached hereto and/or filed herewith, the disclosures of which are incorporated herein by reference as if fully set out at this point.

Thus, the invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A burner or retrofit kit combustion system for industrial or steam generation applications, the burner or retrofit kit combustion system further comprising:
a stream of oxidant;
a stream of primary pure hydrogen (H₂) fuel configured to combust with the oxidant; and
at least one burner nozzle downstream from the oxidant stream and the hydrogen fuel stream, the burner configured to combust the hydrogen fuel with the oxidant.

2. The burner or retrofit kit combustion system of claim 1 wherein said burner or retrofit kit combustion system is incorporated into a boiler system.

3. The burner or retrofit kit combustion system of claim 2 wherein the boiler system is a firetube, watertube, utility, single burner, multiple-burner, side-fired, bottom-fired, roof-fired, tangentially-fired, skid-mounted, field-erected boiler, or a combination thereof.

4. The burner or retrofit kit combustion system of claim 2 further comprising at least one flow valve and control in fluid communication with the stream of hydrogen fuel.

5. The burner or retrofit kit combustion system of claim 1 wherein the burner further comprises a manifold fluidly connected to a plurality of burner nozzles.

6. The burner or retrofit kit combustion system of claim 1 further comprising a stream of secondary fuel configured to combust with the hydrogen fuel and the oxidant for reducing emissions of CO₂.

7. The burner or retrofit kit combustion system of claim 6 wherein the secondary fuel is natural gas, methane, propane, or a combination or mixture thereof.

8. The burner or retrofit kit combustion system of claim 7 wherein the secondary fuel has a concentration of greater than 5% by volume of the overall burner capacity.

9. The burner or retrofit kit combustion system of claim 1 wherein the oxidant is combustion air, pure oxygen, or oxygen-enriched air.

10. The burner or retrofit kit combustion system of claim 9 wherein said oxygen-enriched air comprising an oxygen concentration greater than about 21% by volume.

11. The burner or retrofit kit combustion system of claim 1 further comprising a stream of a flame temperature reducing fluid configured to be introduced to lower the bulk flame temperature of the burner.

12. The burner or retrofit kit combustion system of claim 11 wherein the flame temperature reducing fluid is injected into the burner with the oxidant, the hydrogen fuel, the secondary fuel, or a combination thereof.

13. The burner or retrofit kit combustion system of claim 12 wherein the flame temperature reducing fluid is water, steam, flue gas recirculation, or a combination thereof.

14. The burner or retrofit kit combustion system of claim 13 wherein the steam, the water, and the flue gas recirculation each have variable flow rates to reduce the bulk flame temperature of the burner nozzle.

15. The burner or retrofit kit combustion system of claim 14 wherein the flue gas recirculation has a flow rate greater than about 45% by volume to reduce the bulk flame temperature of the combustion process.

16. The burner or retrofit kit combustion system of claim 14 wherein the steam has a flow rate greater than about 0.35 lbs. of steam/lbs. of hydrogen fuel to reduce the bulk flame temperature of the burner nozzle.

17. The burner or retrofit kit combustion system of claim 14 wherein the water has a flow rate greater than about 1.5 lbs. of water/lbs. of hydrogen fuel to reduce the bulk flame temperature of the burner nozzle.

18. The burner or retrofit kit combustion system of claim 1 having jet stabilization only.

19. A process for industrial applications or steam generation using the burner or retrofit kit

1. on system of claim 1.

20. A burner or retrofit kit combustion system for industrial or steam generation applications, the burner or retrofit kit combustion system further comprising:
a stream of oxidant;
a stream of primary pure hydrogen (H₂) fuel configured to combust with the oxidant;
a stream of secondary fuel configured to combust with the hydrogen fuel and the oxidant for reducing emissions of CO₂;
a stream of a flame temperature reducing fluid configured to be introduced to lower the bulk flame temperature of the burner; and
a plurality of burner nozzles downstream from the oxidant stream, the hydrogen fuel stream, the secondary fuel stream, and the flame temperature reducing fluid stream, the burners configured to combust the hydrogen fuel with the oxidant and the secondary fuel stream.

21. The burner or retrofit kit combustion system of claim 20 wherein said burner or retrofit kit combustion system is incorporated into a boiler system.

22. The burner or retrofit kit combustion system of claim 21 wherein the boiler system is a firetube, watertube, utility, single burner, multiple-burner, side-fired, bottom-fired, roof-fired, tangentially-fired, skid-mounted, field-erected boiler, or a combination thereof.

23. The burner or retrofit kit combustion system of claim 20 further comprising at least one flow valve and control in fluid communication with the stream of hydrogen fuel.

24. The burner or retrofit kit combustion system of claim 20 wherein the burner further comprise a manifold fluidly connected to the plurality of burner nozzles.

25. The burner or retrofit kit combustion system of claim 20 wherein the secondary fuel is natural gas, methane, propane, or a combination or mixture thereof.

26. The burner or retrofit kit combustion system of claim 25 wherein the secondary fuel has a concentration of greater than 5% by volume of the overall burner capacity.

27. The burner or retrofit kit combustion system of claim 20 wherein the oxidant is combustion air, pure oxygen, or oxygen-enriched air.

28. The burner or retrofit kit combustion system of claim 27 wherein said oxygen-enriched air comprising an oxygen concentration greater than about 21% by volume.

29. The burner or retrofit kit combustion system of claim 20 wherein the flame temperature reducing fluid is injected into the burner with the oxidant, the hydrogen fuel, the secondary fuel, or a combination thereof.

30. The burner or retrofit kit combustion system of claim 29 wherein the flame temperature reducing fluid is water, steam, flue gas recirculation, or a combination thereof.

31. The burner or retrofit kit combustion system of claim 30 wherein the steam, the water, and the flue gas recirculation each have variable flow rates to reduce the bulk flame temperature of the burner nozzle.

32. The burner or retrofit kit combustion system of claim 31 wherein the flue gas recirculation has a flow rate greater than about 45% by volume to reduce the bulk flame temperature of the combustion process.

33. The burner or retrofit kit combustion system of claim 31 wherein the steam has a flow rate greater than about 0.35 lbs. of steam/lbs. of hydrogen fuel to reduce the bulk flame temperature of the burner nozzle.

34. The burner or retrofit kit combustion system of claim 31 wherein the water has a flow rate greater than about 1.5 lbs. of water/lbs. of hydrogen fuel to reduce the bulk flame temperature of the burner nozzle.

35. The burner or retrofit kit combustion system of claim 20 having jet stabilization only.

36. A process for industrial applications or steam generation using the burner or retrofit kit combustion system of claim 21.
